(19) United States
(12) Patent Application Publication
(10) Pub. No.: US 2008/0086476 A1
(43) Pub. Date: Apr. 10, 2008

(54) METHOD FOR PROVIDING NEWS SYNDICATION DISCOVERY AND COMPETITIVE AWARENESS

(76) Inventors: Theodore Jack London Shrader, Austin, TX (US); Nathan Christopher Bybee, Austin, TX (US); Jackie Cole Wheeler, Raleigh, NC (US)

Correspondence Address: IBM CORPORATION (SWP), C/O SUITER SWANTZ PC LLO, 14301 FNB PARKWAY, SUITE 220, OMAHA, NE, 68154-5299, US

(21) Appl. No.: 11/538,512

(22) Filed: Oct. 4, 2006

(51) Int. Cl. G06F 17/30

(52) U.S. Cl. 707/10

(57) ABSTRACT

The present invention is a method for providing news syndication discovery and competitive awareness. The method includes generating a first search set, the first search set including at least one URL (Uniform Resource Locator) for being searched to determine if the at least one URL syndicates content from a first content provider's RSS (Rich Site Summary) feed. The method further includes validating the at least one URL of the first search set, the validated URL syndicating content from the first content provider's RSS feed. The method further includes generating a second search set, the second search set including at least one URL (Uniform Resource Locator) which syndicates content from a second content provider's RSS feed. The method further includes providing a report indicating at least one of: identity of at least one validated URL of the first search set; identity of the first content provider's RSS feed content syndicated by the at least one validated URL of the first search set; identity of at least one URL of the second search set; identity of second content provider's RSS feed content syndicated by the at least one URL of the second search set.

### FIELD OF THE INVENTION

The present invention relates to the field of business relations, Web design and development, and particularly to a method for providing news syndication discovery and competitive awareness.

### BACKGROUND OF THE INVENTION

Currently, a number of Web content providers utilize RSS (short for Rich Site Summary), which is an XML format for syndicating Web content. For example, a Web content provider that wants to allow other sites to publish some of its content may create an RSS file and publish it on a Web site. The Web content provider may also register the RSS feed with an RSS publisher for additional distribution and awareness. Users may also subscribe directly to an RSS feed with their client-side RSS readers. By utilizing a RSS feed, Web content providers may allow other parties to quickly and easily receive or syndicate their content. For example, if a Web content provider is a news provider, it may provide its content in the form of an RSS feed which includes: a news story headline; an abstract of the news story; and a link to a Web page which includes the full news story. A subscriber to the news provider's content may automatically receive the RSS feed through a RSS reader. Further, Web administrators may automatically incorporate the news provider's content (RSS feed headlines, etc.) on their Web pages for access by users viewing their respective Web pages. However, current methods of syndicating content, as described above, do not allow the Web content provider (i.e., the creator of the RSS feed) to know the context in which their RSS feed is being used. For example, a Web content provider may not always know how its content is being used (ex-which RSS feeds are being accessed) or by whom. Further, current methods of syndicating content do not allow the Web content provider (i.e., the creator of the RSS feed) to know which competitor or complimentary RSS feeds are being accessed by subscribers and/or recipients of the content of the Web content provider.

Therefore, it may be desirable to have a method for providing news syndication discovery and competitive awareness.

### SUMMARY OF THE INVENTION

Accordingly, an embodiment of the present invention is directed to a method for providing news syndication discovery and competitive awareness. The method includes generating a first search set, the first search set including at least one URL (Uniform Resource Locator) for being searched to determine if the at least one URL syndicates content from a first content provider's RSS (Rich Site Summary) feed. The method further includes validating the at least one URL of the first search set, the validated URL syndicating content from the first content provider's RSS feed. The method further includes generating a second search set, the second search set including at least one URL (Uniform Resource Locator) which syndicates content from a second content provider's RSS feed. The method further includes providing a report indicating at least one of: identity of at least one validated URL of the first search set; identity of the first content provider's RSS feed content syndicated by the at least one validated URL of the first search set; identity of at least one URL of the second search set; identity of second content provider's RSS feed content syndicated by the at least one URL of the second search set.

In an additional embodiment, the present invention is directed to a method for providing news syndication discovery and competitive awareness, including: generating a first search set, the first search set including at least one URL (Uniform Resource Locator) for being searched to determine if the at least one URL syndicates content from a first content provider's RSS (Rich Site Summary) feed; validating the at least one URL of the first search set, the validated URL syndicating content from the first content provider's RSS feed; generating a second search set, the second search set including at least one URL (Uniform Resource Locator) which syndicates content from a second content provider's RSS feed; and providing a report indicating at least one of: identity of at least one validated URL of the first search set; identity of the first content provider's RSS feed content syndicated by the at least one validated URL of the first search set; identity of at least one URL of the second search set; identity of second content provider's RSS feed content syndicated by the at least one URL of the second search set, wherein generating a second search set and validating are performed concurrently by referencing a RSS content URL database of the second content provider.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a flow chart illustrating a method for providing news syndication discovery and competitive awareness in accordance with an exemplary embodiment of the present invention;

FIG. 2 is a flow chart illustrating steps included in generating a first search set, wherein generating a first search set is a step included in a method, as shown in FIG. 1, for providing news syndication discovery and competitive awareness in accordance with an exemplary embodiment of the present invention;

FIG. 3 is a flow chart illustrating steps included in validating at least one URL of a first search set, wherein validating at least one URL of a first search set is a step included in a method, as shown in FIG. 1, for providing news syndication discovery and competitive awareness in accordance with an exemplary embodiment of the present invention;

FIG. 4 is a flow chart illustrating steps included in generating a second search set, wherein generating a second search set is a step included in a method, as shown in FIG. 1, for providing news syndication discovery and competitive awareness in accordance with an exemplary embodiment of the present invention; and

FIG. 5 is a flow chart illustrating a method for providing news syndication discovery and competitive awareness in accordance with an alternative exemplary embodiment of the present invention.

### DETAILED DESCRIPTION OF THE INVENTION

Reference will now be made in detail to the presently preferred embodiments of the invention, examples of which are illustrated in the accompanying drawings.

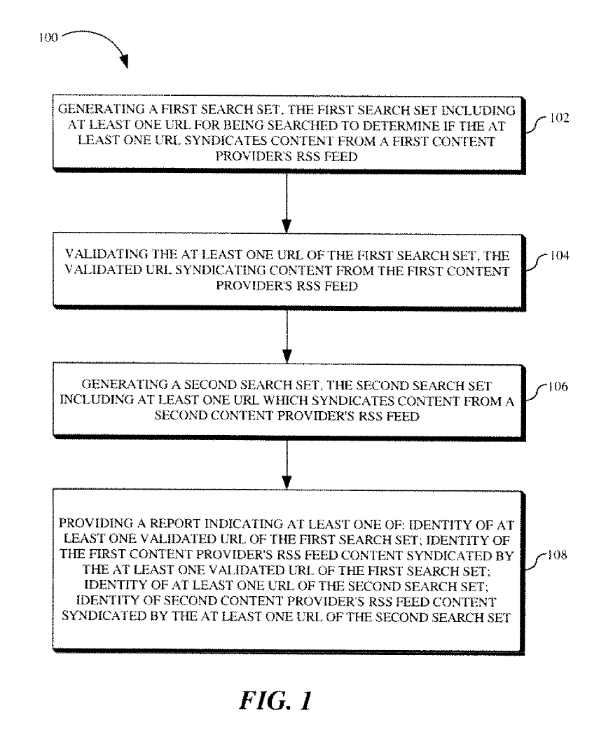

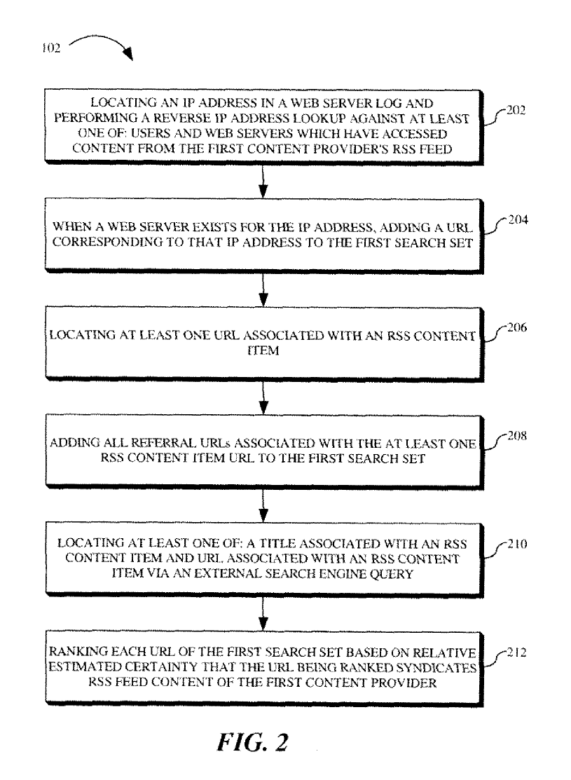

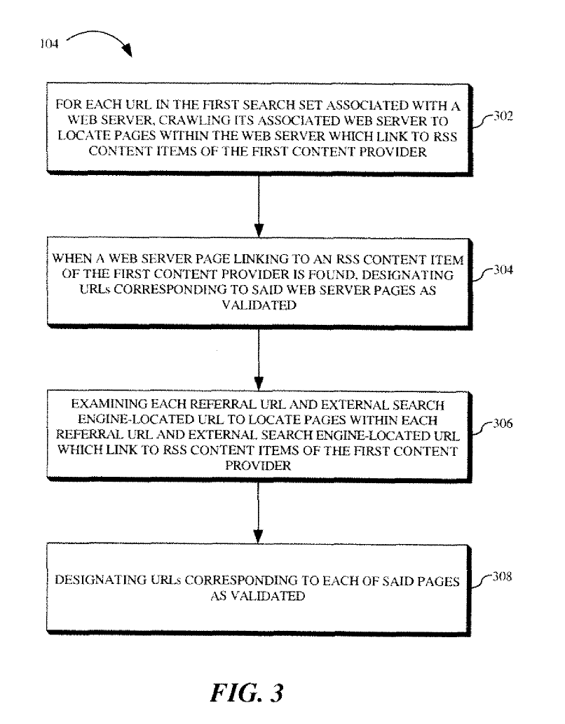

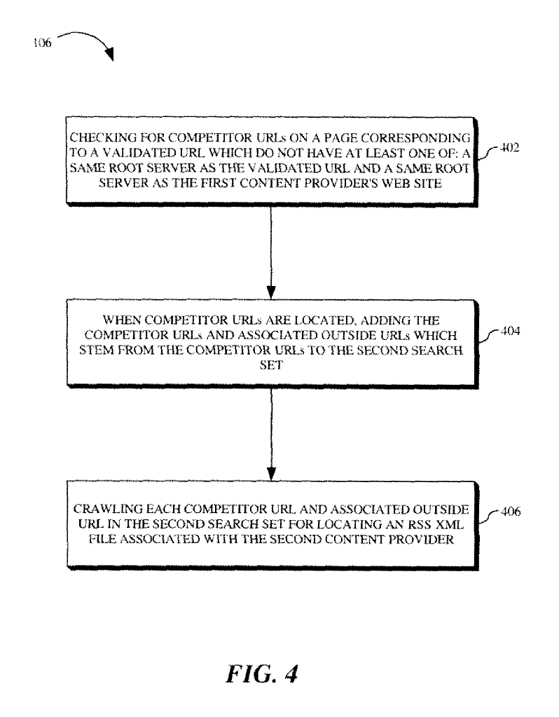

Referring generally to FIGS. 1-4 flow charts illustrating a method for providing news syndication discovery and competitive awareness in accordance with exemplary embodiments of the present invention are shown. In a current embodiment, the method 100 includes generating a first search set, the first search set including at least one Uniform Resource Locator (URL) for being searched to determine if the at least one URL syndicates content from a first content provider's RSS (Rich Site Summary) feed 102. In a present embodiment, the step of generating a first search set 102 includes locating an Internet Protocol (IP) address in a Web server log and performing a reverse IP address lookup against at least one of: users and Web servers which have accessed content from the first content provider's RSS feed 202. In further embodiments, the step of generating a first search set 102 further includes, when a Web server exists for the IP address, adding a URL corresponding to that IP address to the first search set 204. For example, port 80 (i.e., HyperText Transfer Protocol (HTTP) port) may be examined to determine if a Web server exists for the IP address. If so, the URL (i.e., a top-level URL) corresponding to that IP address is added to the first search set.

In additional embodiments, the step of generating a first search set 102 further includes locating at least one URL associated with an RSS content item 206. For instance, RSS content items may be tagged with a unique URL or tracking tag to help determine where traffic to the content items originated. In still further embodiments, the step of generating a first search set 102 further includes adding all referral URLs associated with the at least one RSS content item URL to the first search set 208. In current embodiments, the step of generating a first search set 102 further includes locating at least one of: a title associated with an RSS content item and a URL associated with an RSS content item via an external search engine query 210. This step may allow capture of URLs which may syndicate content from the first content provider's RSS feed, but do not yet send traffic to unique URLs on the first content provider's web site. In further embodiments, the step of generating a first search set further includes ranking each URL of the first search set based on relative estimated certainty that the URL being ranked syndicates RSS feed content of the first content provider 212. For instance, URLs found via search engine may be given a higher certainty weight/ranking than URLs or IP addresses added due to the discovery of Web servers. Further, processing time during validation (which will be discussed below) may be reduced by searching the higher-ranked URLs first.

It is contemplated that URLs or IP addresses may be excluded from or “rooted out” of the first search set due to being invalid. For example, referral URLs and/or IP addresses may be spoofed, and thus, may not always be valid. Also, an IP address may be dynamic and/or may not be hosted by a Web server as it may be associated with a user accessing the RSS feed via the user's RSS reader. In a present embodiment, the method 100 further includes validating the at least one URL of the first search set, the validated URL syndicating content from the first content provider's RSS feed 104. In an exemplary embodiment, the step of validating the at least one URL of the first search set 104 includes, for each URL in the first search set associated with a Web server, crawling its associated Web server to locate pages within the Web server which link to RSS content items of the first content provider 302. For instance, the located pages may contain links to RSS content items with the unique URL tagging to the first content provider's Web site. In further embodiments, the step of validating the at least one URL of the first search set 104 includes, when a Web server page linking to an RSS content item of the first content provider is found, designating URLs corresponding to said Web server pages as validated 304. In additional embodiments, the step of validating the at least one URL of the first search set 104 includes, examining each referral URL and external search engine-located URL which link to RSS content items of the first content provider 306. In still further embodiments, the step of validating the at least one URL of the first search set 104 includes, designating URLs corresponding to each of said pages as validated 308.

The method 100 further includes generating a second search set, the second search set including at least one URL which syndicates content from a second content provider's RSS feed 106. In an exemplary embodiment, the step of generating a second search set 106 includes checking for competitor URLs on a page corresponding to a validated URL which do not have at least one of: a same root server as the validated URL and a same root server as the first content provider's Web site 402. Such checking may allow for discovery of URLs which point to other servers, possibly indicating that competitor content is being syndicated. In further embodiments, the step of generating a second search set 106 includes, when competitor URLs are located, adding the competitor URLs and associated outside URLs which stem from the competitor URLs to the second search set 404. In additional embodiments, the step of generating a second search set 106 includes, crawling each competitor URL and associated outside URL in the second search set for locating an RSS XML file associated with the second content provider 406. It is contemplated that the second search set may include URLs from more than one Web content provider.

The method 100 further includes providing a report indicating at least one of: identity of at least one validated URL of the first search set; identity of the first content provider's RSS feed content syndicated by the at least one validated URL of the first search set; identity of at least one URL of the second search set; identity of the second content provider's RSS feed content syndicated by the at least one URL of the second search set 108. For instance, results of the report may be stored in a relational database (i.e.—a database structured in accordance with the relational model). Further, multiple customized reports may be presented and URLs of interest may be visited for additional examination. For example, the present invention may be run multiple times over a period of time to help provide a historical log of who is using the first content provider's content, as well as who is using competitor (ex.—a second content provider's) content. Such information may be utilized for determining which keywords or subjects are most effective in encouraging syndication. Additionally, the present invention may be utilized to analyze/monitor specific, competitor content providers to determine the effectiveness of the competitor's RSS reach and to discover potential content-publishing Web sites.

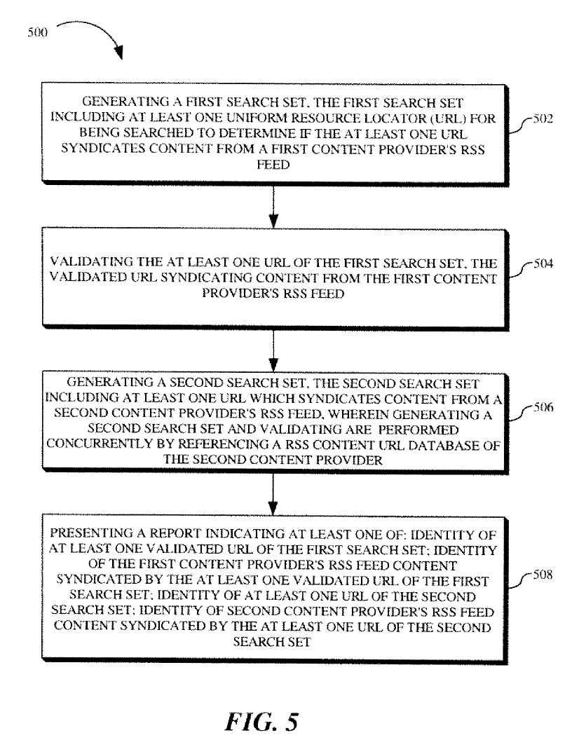

Referring to FIG. 5, a flow chart illustrating a method for providing news syndication discovery and competitive awareness in accordance with an alternative embodiment of the present invention. The method 500 includes generating a first search set, the first search set including at least one URL (Uniform Resource Locator) for being searched to determine if the at least one URL syndicates content from a first content provider's RSS (Rich Site Summary) feed 502. The method 500 further includes validating the at least one URL of the first search set, the validated URL syndicating content from the first content provider's RSS feed 504. In an exemplary embodiment, the method 500 further includes generating a second search set, the second search set including at least one URL which syndicates content from a second content provider's RSS feed 506. In further embodiments, the method 500 further includes providing a report indicating at least one of: identity of at least one validated URL of the first search set; identity of the first content provider's RSS feed content syndicated by the at least one validated URL of the first search set; identity of at least one URL of the second search set; identity of the second content provider's RSS feed content syndicated by the at least one URL of the second search set 508. In the illustrated embodiment, the steps of generating the second search set 506 and validating the at least one URL of the first search set 504 are performed concurrently by referencing a RSS content URL database of the second content provider.

It is contemplated that the invention may take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention may take the form of a computer program product accessible from a computer-usable or computer-readable medium providing program code for use by or in connection with a computer or any instruction execution system. For the purposes of this description, a computer-usable or computer readable medium may be any apparatus that may contain, store, communicate, propagate, or transport the program for use by or in connection with the instruction execution system, apparatus, or device.

It is further contemplated that the medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements may include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, microphone, speakers, displays, pointing devices, and the like) may be coupled to the system either directly or through intervening I/O controllers.

Network adapters may also be coupled to the system to enable the data processing system to become coupled to other data processing systems or storage devices through intervening private or public networks. Modems, cable modem and Ethernet cards are just a few of the currently available types of network adapters.

It is understood that the specific order or hierarchy of steps in the foregoing disclosed methods are examples of exemplary approaches. Based upon design preferences, it is understood that the specific order or hierarchy of steps in the method can be rearranged while remaining within the scope of the present invention. The accompanying method claims present elements of the various steps in a sample order, and are not meant to be limited to the specific order or hierarchy presented.

It is believed that the present invention and many of its attendant advantages are to be understood by the foregoing description, and it is apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A method for providing news syndication discovery and competitive awareness, comprising:
generating a first search set, the first search set including at least one URL (Uniform Resource Locator) for being searched to determine if the at least one URL syndicates content from a first content provider's RSS (Rich Site Summary) feed;
validating the at least one URL of the first search set, the validated URL syndicating content from the first content provider's RSS feed;
generating a second search set, the second search set including at least one URL (Uniform Resource Locator) which syndicates content from a second content provider's RSS feed; and
providing a report indicating at least one of: identity of at least one validated URL of the first search set; identity of the first content provider's RSS feed content syndicated by the at least one validated URL of the first search set; identity of at least one URL of the second search set; identity of second content provider's RSS feed content syndicated by the at least one URL of the second search set.

2. A method as claimed in claim 1, wherein the step of generating a first search set includes:
locating an IP (Internet Protocol) address in a Web server log and performing a reverse IP address lookup against at least one of: users and Web servers which have accessed content from the first content provider's RSS feed; and
when a Web server exists for the IP address, adding a URL corresponding to that IP address to the first search set.

3. A method as claimed in claim 2, wherein the step of generating a first search set further includes:
locating at least one URL associated with an RSS content item; and
adding all referral URLs associated with the at least one RSS content item URL to the first search set.

4. A method as claimed in claim 3, wherein the step of generating a first search set further includes:
locating at least one of: a title associated with an RSS content item and URL associated with an RSS content item via an external search engine query.

5. A method as claimed in claim 4, wherein the step of generating a first search set further includes:
ranking each URL of the first search set based on relative estimated certainty that the URL being ranked syndicates RSS feed content of the first content provider.

6. A method as claimed in claim 5, wherein the step of validating includes:
for each URL in the first search set associated with a Web server, crawling its associated Web server to locate pages within the Web server which link to RSS content items of the first content provider; and
when a Web server page linking to an RSS content item of the first content provider is found, designating URLs corresponding to said Web server pages as validated;
examining each referral URL and external search engine-located URL to locate pages within each referral URL and external search engine-located URL which link to RSS content items of the first content provider; and
designating URLs corresponding to each of said pages as validated.

7. A method as claimed in claim 6, wherein the step of generating a second search set includes:
checking for competitor URLs on a page corresponding to a validated URL which do not have at least one of: a same root server as the validated URL and a same root server as the first content provider's Web site; and
when competitor URLs are located, adding the competitor URLs and associated outside URLs which stem from the competitor URLs to the second search set; and
crawling each competitor URL and associated outside URL in the second search set for locating an RSS XML file associated with the second content provider.

8. A computer program product, comprising:
a computer useable medium including computer usable program code for performing a method for providing news syndication discovery and competitive awareness including:
computer usable program code for generating a first search set, the first search set including at least one URL (Uniform Resource Locator) for being searched to determine if the at least one URL syndicates content from a first content provider's RSS (Rich Site Summary) feed;
computer usable program code for validating the at least one URL of the first search set, the validated URL syndicating content from the first content provider's RSS feed;
computer usable program code for generating a second search set, the second search set including at least one URL (Uniform Resource Locator) which syndicates content from a second content provider's RSS feed; and
computer usable program code for providing a report indicating at least one of: identity of at least one validated URL of the first search set; identity of the first content provider's RSS feed content syndicated by the at least one validated URL of the first search set; identity of at least one URL of the second search set; identity of second content provider's RSS feed content syndicated by the at least one URL of the second search set.

9. A computer program product as claimed in claim 8, wherein the step of generating a first search set includes:
locating an IP (Internet Protocol) address in a Web server log and performing a reverse IP address lookup against at least one of: users and Web servers which have accessed content from the first content provider's RSS feed; and
when a Web server exists for the IP address, adding a URL corresponding to that IP address to the first search set.

10. A computer program product as claimed in claim 9, wherein the step of generating a first search set further includes:
locating at least one URL associated with an RSS content item; and
adding all referral URLs associated with the at least one RSS content item URL to the first search set.

11. A computer program product as claimed in claim 10, wherein the step of generating a first search set further includes:
locating at least one of: a title associated with an RSS content item and URL associated with an RSS content item via an external search engine query.

12. A computer program product as claimed in claim 11, wherein the step of generating a first search set further includes:
ranking each URL of the first search set based on relative estimated certainty that the URL being ranked syndicates RSS feed content of the first content provider.

13. A computer program product as claimed in claim 12, wherein the step of validating includes:
for each URL in the first search set associated with a Web server, crawling its associated Web server to locate pages within the Web server which link to RSS content items of the first content provider; and
when a Web server page linking to an RSS content item of the first content provider is found, designating URLs corresponding to said Web server pages as validated.

14. A computer program product as claimed in claim 13, wherein the step of validating further includes:
examining each referral URL and external search engine-located URL to locate pages within each referral URL and external search engine-located URL which link to RSS content items of the first content provider; and
designating URLs corresponding to each of said pages as validated.

15. A computer program product as claimed in claim 14, wherein the step of generating a second search set includes:
checking for competitor URLs on a page corresponding to a validated URL which do not have at least one of: a same root server as the validated URL and a same root server as the first content provider's Web site; and
when competitor URLs are located, adding the competitor URLs and associated outside URLs which stem from the competitor URLs to the second search set.

16. A computer program product as claimed in claim 15, wherein the step of generating a second search set includes:
crawling each competitor URL and associated outside URL in the second search set for locating an RSS XML file associated with the second content provider.

17. A method for providing news syndication discovery and competitive awareness, comprising:
generating a first search set, the first search set including at least one URL (Uniform Resource Locator) for being searched to determine if the at least one URL syndicates content from a first content provider's RSS (Rich Site Summary) feed;
validating the at least one URL of the first search set, the validated URL syndicating content from the first content provider's RSS feed;
generating a second search set, the second search set including at least one URL (Uniform Resource Locator) which syndicates content from a second content provider's RSS feed; and
providing a report indicating at least one of: identity of at least one validated URL of the first search set; identity of the first content provider's RSS feed content syndicated by the at least one validated URL of the first search set; identity of at least one URL of the second search set; identity of second content provider's RSS feed content syndicated by the at least one URL of the second search set,
wherein generating a second search set and validating are performed concurrently by referencing a RSS content URL database of the second content provider.

18. A method as claimed in claim 17, wherein the step of generating a first search set includes:
locating an IP (Internet Protocol) address in a Web server log and performing a reverse IP address lookup against at least one of: users and Web servers which have accessed content from the first content provider's RSS feed;
when a Web server exists for the IP address, adding a URL corresponding to that IP address to the first search set;
locating at least one URL associated with an RSS content item;
adding all referral URLs associated with the at least one RSS content item URL to the first search set;
locating at least one of: a title associated with an RSS content item and URL associated with an RSS content item via an external search engine query; and
ranking each URL of the first search set based on relative estimated certainty that the URL being ranked syndicates RSS feed content of the first content provider.

19. A method as claimed in claim 18, wherein the step of validating includes:
for each URL in the first search set associated with a Web server, crawling its associated Web server to locate pages within the Web server which link to RSS content items of the first content provider;
when a Web server page linking to an RSS content item of the first content provider is found, designating URLs corresponding to said Web server pages as validated;
examining each referral URL and external search engine-located URL to locate pages within each referral URL and external search engine-located URL which link to RSS content items of the first content provider; and
designating URLs corresponding to each of said pages as validated.

20. A method as claimed in claim 19, wherein the step of generating a second search set includes:
checking for competitor URLs on a page corresponding to a validated URL which do not have at least one of: a same root server as the validated URL and a same root server as the first content provider's Web site;
when competitor URLs are located, adding the competitor URLs and associated outside URLs which stem from the competitor URLs to the second search set; and
crawling each competitor URL and associated outside URL in the second search set for locating an RSS XML file associated with the second content provider.
